(19) United States
(12) Patent Application Publication
(10) Pub. No.: US 2006/0139272 A1
(43) Pub. Date: Jun. 29, 2006

(54) Gamma voltage generating apparatus and method of testing a gamma voltage

(75) Inventors: Kil-Soo Choi, Gyeonggi-do (KR); Kon-Ho Lee, Seoul (KR)

Correspondence Address: DLA PIPER RUDNICK GRAY CARY US, LLP, 2000 UNIVERSITY AVENUE, E. PALO ALTO, CA, 94303-2248, US

(73) Assignee: Samsung Electronics Co., Ltd.

(21) Appl. No.: 11/190,641

(22) Filed: Jul. 27, 2005

(30) Foreign Application Priority Data
Dec. 28, 2004 (KR) 10-2004-113681

(51) Int. Cl. G09G 3/36

(52) U.S. Cl. 345/89

(57) ABSTRACT

An apparatus for generating a gamma voltage capable of testing the gamma voltage includes a gamma voltage selection unit, a gamma voltage output unit and a gamma voltage test unit. The gamma voltage selection unit selects at least one of a plurality of source gamma voltages generated by a resistor string to output the at least one selected source gamma voltage. The gamma voltage output unit provides a plurality of gamma voltages based on the source gamma voltages received from the resistor string and the at least one selected source gamma voltage received from the gamma voltage selection unit. The gamma voltage test unit selects at least one of the gamma voltages received from the gamma voltage output unit based on a gamma test signal externally provided. Therefore, an actual output level of the gamma voltage generated in a driver IC may be precisely measured.

### CROSS REFERENCE TO RELATED APPLICATION

This application claims priority under 35 USC § 119 to Korean Patent Application No. 2004-113681 filed on Dec. 28, 2004, the contents of which are herein incorporated by reference in its entirety for all purposes.

### BACKGROUND OF THE INVENTION

1. Field of the Invention

The present invention relates to an apparatus for generating a gamma voltage and a method of testing the gamma voltage.

2. Description of the Related Art

Generally, a gamma value in a gamma curve of a display device represents a degree of brightness based on a gray voltage outputted by a source driver IC of a data driver.

For example, in a normally white mode, light transmittance is inversely proportional to a gray voltage outputted by the source driver IC. That is, the gray level corresponding to white color is represented when the gray voltage outputted by the source driver IC is low, and a gray level corresponding to black color is represented when the gray voltage is high.

Thus, the source driver IC provides a plurality of gray voltages to represent many gray levels ranging from the white level to the black level. The gray voltage levels are determined using a register and a resistant component of the source driver IC.

Generally, a gamma voltage generation apparatus is implemented in an integrated circuit (IC), which has a built-in gamma voltage adjustment register to output the gamma voltage corresponding to the respective gray levels. However, in an actual implementation where the gamma voltage generation apparatus IC is mounted on the liquid crystal display and driven while interfacing with other component devices, a theoretically calculated gamma voltage does not match the corresponding gray level.

Thus, when a display defect such as a gray pattern or a moiré pattern is generated in an image on a display, the output level of an actual gamma voltage that is supposed to correspond to a particular gray level is measured to analyze the display defects. As this type of analysis is cumbersome, there exists a need for a gamma generation apparatus in which the gamma voltage corresponding to the respective gray levels is precisely measurable.

### SUMMARY OF THE INVENTION

Accordingly, the present invention is provided to substantially obviate one or more problems due to limitations and disadvantages of the related art.

Exemplary embodiments of the present invention may provide an apparatus for generating a gamma voltage capable of testing the gamma voltage.

In some embodiments of the present invention, the apparatus for generating the gamma voltage includes a gamma adjustment register, a gamma reference voltage generation unit, a gamma voltage selection unit, a gamma voltage output unit and a gamma voltage test unit. The gamma adjustment register provides first and second register values for selecting the gamma voltage. The gamma reference voltage generation unit has a first end coupled to a first supply voltage and a second end coupled to a second supply voltage to output a plurality of source gamma voltages based on the first register value. The gamma voltage selection unit selects at least one of the source gamma voltages based on the second register value to output the at least one selected source gamma voltage. The gamma voltage output unit provides a plurality of gamma voltages based on the source gamma voltages received from the gamma reference voltage generation unit and the at least one selected source gamma voltage received from the gamma voltage selection unit. The gamma voltage test unit selects at least one of the gamma voltages outputted by the gamma voltage output unit based on a gamma test signal externally provided.

In some embodiments, the first supply voltage is relatively higher than the second supply voltage, and the gamma voltages outputted by the gamma voltage output unit have output levels corresponding to respective gray levels.

In some embodiments, the gamma test signal has a digital data varying according to a gray voltage to be tested and a bit number of the gamma test signal is adjusted according to a number of gray levels to be tested.

In some embodiments, the gamma adjustment register includes a gradient adjustment register configured to output the first register value for adjusting a gradient of the gray voltage relative to a gray level, an amplitude adjustment register configured to output the first register value for adjusting an amplitude of the gray voltage relative to the gray level, and a fine adjustment register configured to output the second register value for fine adjustment of the gray voltage relative to the gray level.

In some embodiments, the gamma reference voltage generation unit includes a resistor string and the resistor string includes at least one fixed resistor and at least one variable resistor.

In other exemplary embodiments of the present invention, the apparatus for generating a gamma voltage capable of testing the gamma voltage includes a gamma voltage selection unit, a gamma voltage output unit and a gamma voltage test unit. The gamma voltage selection unit selects at least one of a plurality of source gamma voltages generated by a resistor string to output the at least one selected source gamma voltage. The gamma voltage output unit provides a plurality of gamma voltages based on the source gamma voltages received from the resistor string and the at least one selected source gamma voltage received from the gamma voltage selection unit. The gamma voltage test unit selects at least one of the gamma voltages received from the gamma voltage output unit based on a gamma test signal externally provided.

In other exemplary embodiments of the present invention, the apparatus for generating a gamma voltage capable of testing the gamma voltage includes a gamma voltage selection unit, a gamma voltage output unit and a gamma voltage test unit. The gamma voltage selection unit selects at least one of a plurality of source gamma voltages generated by a resistor string to output the at least one selected source gamma voltage. The gamma voltage output unit provides a plurality of gamma voltages based on the source gamma voltages received from the resistor string and the at least one selected source gamma voltage received from the gamma voltage selection unit. The gamma voltage test unit outputs at least one gamma voltage that is set as a default value out of the gamma voltages that are outputted by the gamma voltage output unit.

Exemplary embodiments of the present invention may also provide a method of testing a gamma voltage. In the method, first and second register values for selecting the gamma voltage are provided. A voltage difference between a first supply voltage and a second supply voltage is divided to output a plurality of source gamma voltages based on the first register value. At least one of the source gamma voltages is selected based on the second register value to output the at least one selected source gamma voltage. A plurality of gamma voltages are outputted based on the source gamma voltages that are in turn outputted based on the first and second register values. At least one gamma voltage is selected from the gamma voltages based on a gamma test signal externally provided.

The present invention allows a precise measurement of gamma voltage levels using an external output pin of the IC and a test instruction. The measurement of the gamma voltage is used in gamma tuning, improving a display quality, analyzing defects and generally operating a device.

### BRIEF DESCRIPTION OF THE DRAWINGS

The above and other advantages of the present invention will become readily apparent by reference to the following detailed description when considered in conjunction with the accompanying drawings wherein:

FIG. 1 is a schematic block diagram illustrating an apparatus for generating a gamma voltage according to an exemplary embodiment of the present invention;

FIG. 2 is a detailed block diagram illustrating the apparatus for generating a gamma voltage in FIG. 1;

FIGS. 3A through 3C are graphs showing a gray voltage adjusted by a gamma adjustment register in FIG. 2;

FIG. 4 is a block diagram illustrating an exemplary gamma voltage test unit in FIG. 2 according to an exemplary embodiment of the present invention;

FIG. 5 is a block diagram illustrating an exemplary gamma voltage test unit in FIG. 2 according to another exemplary embodiment of the present invention;

FIG. 6 is a schematic block diagram illustrating an apparatus for generating a gamma voltage according to another exemplary embodiment of the present invention;

FIG. 7 is a block diagram illustrating a liquid crystal display device according to an exemplary embodiment of the present invention; and

FIG. 8 is a block diagram illustrating an operation of the liquid crystal display device in FIG. 7.

### DESCRIPTION OF THE EXEMPLARY EMBODIMENTS

Hereinafter, the present invention will be explained in detail with reference to the accompanying drawings.

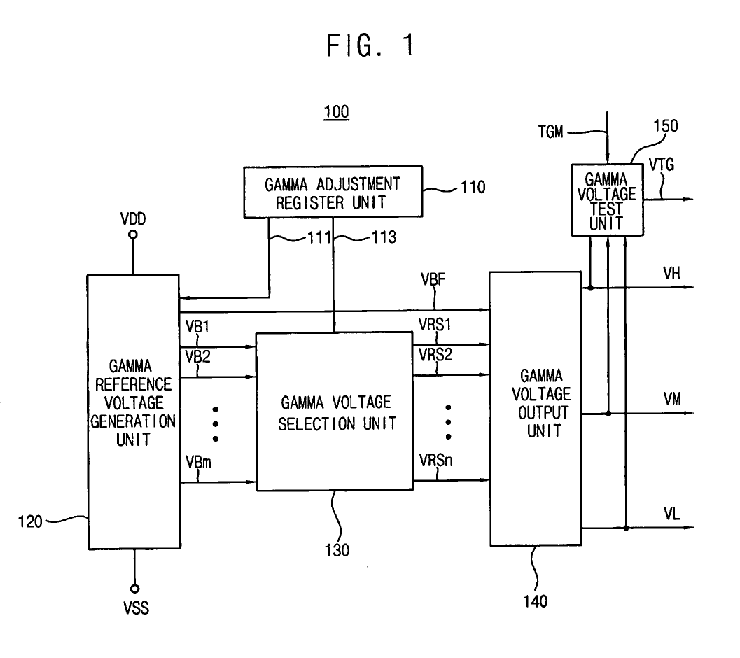

FIG. 1 is a block diagram illustrating an apparatus for generating a gamma voltage according to an exemplary embodiment of the present invention.

Referring to FIG. 1, the apparatus for generating the gamma voltage includes a gamma adjustment register 110, a gamma reference voltage generation unit 120, a gamma voltage selection unit 130, a gamma voltage output unit 140 and a gamma voltage test unit 150.

The gamma adjustment register 110 provides the gamma reference voltage generation unit 120 with a first register value 111 for selecting a gamma voltage and provides the gamma voltage selection unit 130 with a second register value 113 for selecting the gamma voltage.

The gamma reference voltage generation unit 120 has a first end coupled to a first supply voltage and a second end coupled to a second supply voltage. The gamma reference voltage generation unit 120 outputs a fixed source gamma voltage VBF to the gamma voltage output unit 140 and m variable source gamma voltages VB1, VB2, . . . , VBm to the gamma voltage selection unit 130 based on the first register value 111. For example, the first supply voltage corresponds to a power supply VDD and the second supply voltage corresponds to VSS.

The gamma voltage selection unit 130 selects n variable source gamma voltages VRS1, VRS2, . . . , VRSn from the m variable source gamma voltages VB1, VB2, . . . , VBm based on the second register value 113. The n variable source gamma voltages VRS1, VRS2, . . . , VRSn are provided to the gamma voltage output unit 140.

The gamma voltage output unit 140 receives the fixed source gamma voltage VBF from the gamma reference voltage generation unit 120 and the selected n variable source gamma voltages VRS1, VRS2, . . . , VRSn from the gamma voltage selection unit 130 to output gamma voltages VH, VM and VL having different voltage levels.

The gamma voltage test unit 150 selects at least one gamma voltage from the gamma voltages VH, VM and VL based on a gamma test signal TGM provided externally, to output the at least one selected gamma voltage as a test gamma voltage VTG.

As described above, the gamma voltage is separately drawn out from an output terminal of a gamma voltage generating apparatus. This way, the output level of the gamma voltage is precisely measured.

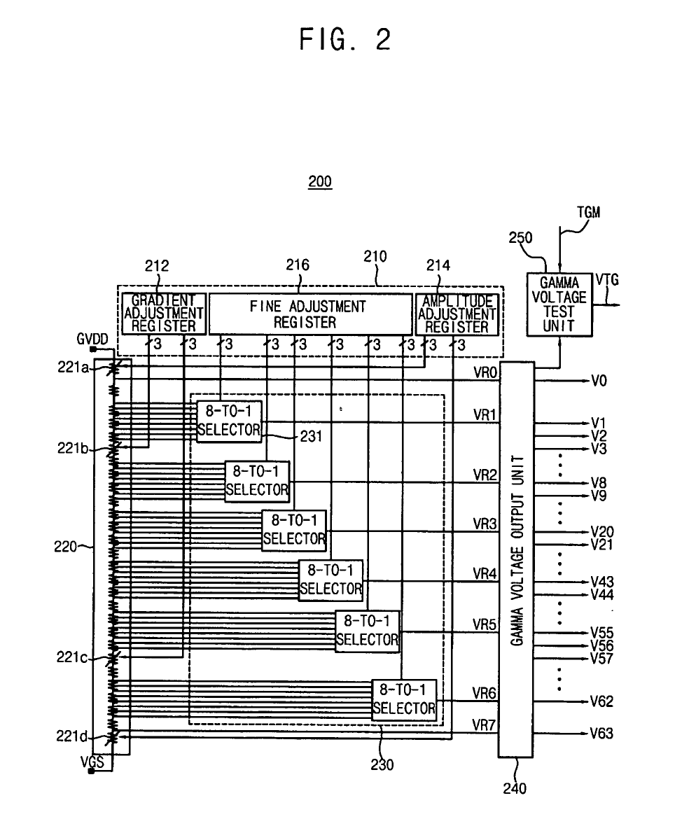

FIG. 2 is a detailed block diagram illustrating an apparatus for generating a gamma voltage according to an exemplary embodiment of the present invention.

Referring to FIG. 2, a gamma voltage generating apparatus 200 includes a gamma adjustment register 210, a gamma reference voltage generation unit 220, a gamma voltage selection unit 230, a gamma voltage output unit 240 and a gamma voltage test unit 250.

The gamma adjustment register 210 includes a gradient adjustment register 212, an amplitude adjustment register 214 and a fine adjustment register 216 to output respective register values for selecting a gamma voltage to the gamma reference voltage generation unit 220 and the gamma voltage selection unit 230.

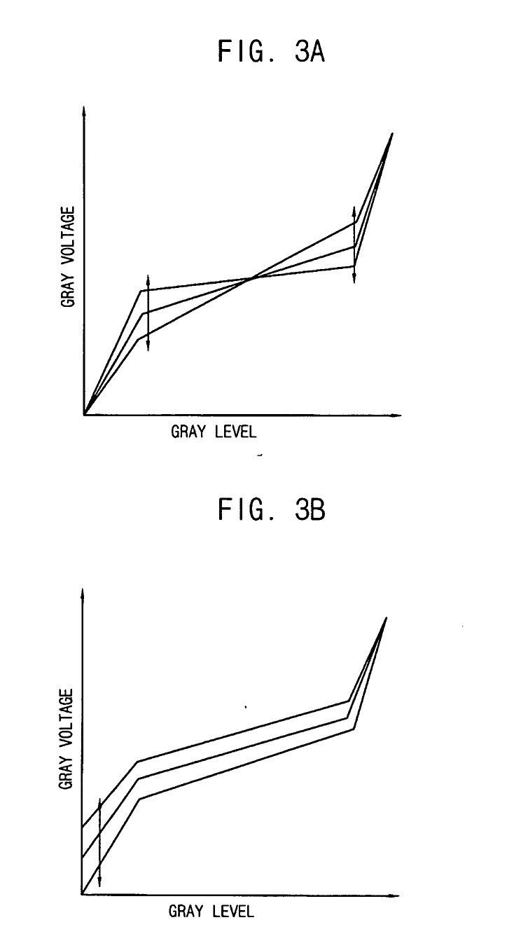

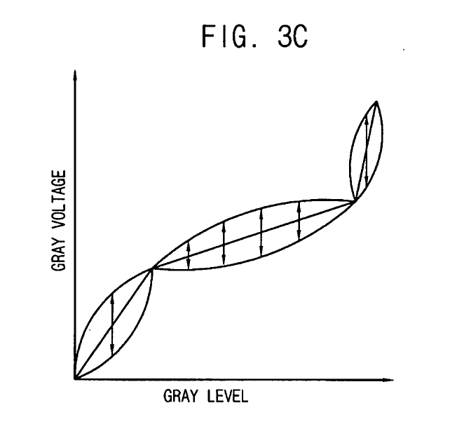

Depending on the register values outputted by the gradient adjustment register 212, the amplitude adjustment register 214 and the fine adjustment register 216, a plurality of gamma voltages V0, V1, V2, . . . , V62 and V63 are outputted by the gamma voltage output unit 240 to define different gamma curves as shown in FIGS. 3A through 3C.

Particularly, the gradient adjustment register 212 provides the gamma reference voltage generation unit 220 with first register values for adjusting a gradient of the gray voltage according to a gray level. Accordingly, the gamma voltages V0, V1, V2, . . . , V62 and V63 outputted by the gamma voltage output unit 240 define different gamma curves as those shown in FIG. 3A.

The amplitude adjustment register 214 provides the gamma reference voltage generation unit 220 with second register values for adjusting an amplitude of the gray voltage relative to the gray level. Accordingly, the gamma voltages V0, V1, V2, V62 and V63 outputted by the gamma voltage output unit 240 define different gamma curves as those shown in FIG. 3B.

The fine adjustment register 216 provides the gamma voltage selection unit 230 with third register values for finely adjusting the gray voltage relative to the gray level. Accordingly, the gamma voltages V0, V1, V2, . . . , V62, V63 outputted by the gamma voltage output unit 240 define different gamma curves as those shown in FIG. 3C.

Referring now to FIG. 2, the gamma reference voltage generation unit 220 includes a resistor string having a plurality of resistors serially coupled to one another between a gamma supply voltage GVDD and a ground VGS.

The resistor string generates gamma reference voltages corresponding to respective gray levels by dividing a voltage difference between the gamma supply voltage GVDD and the ground VGS using the plurality of resistors. The gamma reference voltages are provided to the gamma voltage selection unit 230 and the gamma voltage output unit 240.

The resistor string includes fixed resistors and variable resistors to divide the voltage difference between the gamma supply voltage GVDD and the ground VGS. The variable resistors include first, second, third and fourth variable resistors 221a, 221b, 221c and 221d. However, it may be noted that the resistor string may utilize any number of the variable resistors.

The gamma voltage selection unit 230 includes six selectors 231. Each of the selectors 231 selects one of eight gamma reference voltages based on the second register value having three bits provided from the fine adjustment register 216. The six selected gamma reference voltages VR1, VR2, . . . , VR6 are outputted by the six selectors 231 to the gamma voltage output unit 240.

The gamma voltage output unit 240 outputs a plurality of the gamma voltages V0, V1, V2, . . . , V62 and V63 based on source gamma voltages VR0 and VR7 provided from the gamma reference voltage generation unit 220 and the six gamma reference voltages VR1, VR2, . . . , VR6 provided from the gamma voltage selection unit 230.

The gamma voltage test unit 250 selects at least one of the plurality of the gamma voltages V0, V1, V2, . . . , V62 and V63 based on a gamma test signal TGM received from an external source and outputs the at least one selected gamma voltage as a test gamma voltage VTG.

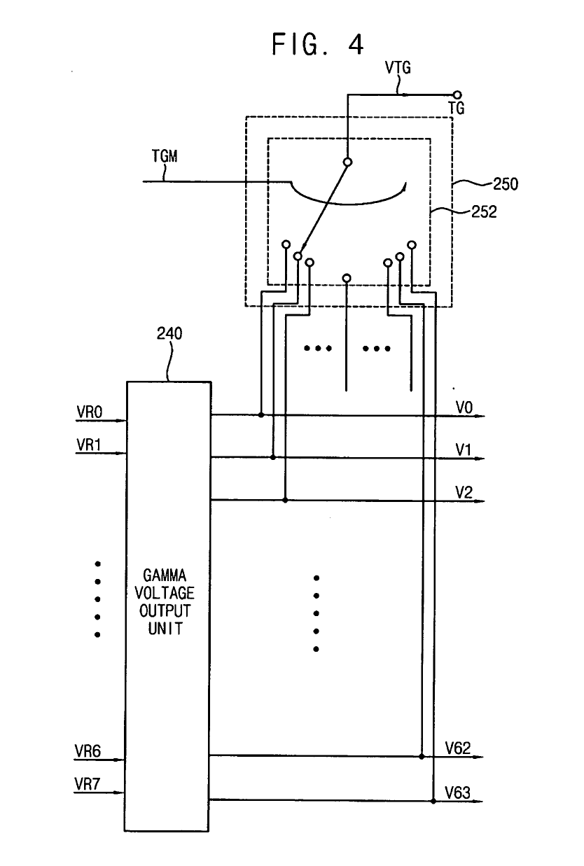

The gamma voltage test unit 250 will be described in more detail with reference to FIG. 4.

FIG. 4 is a block diagram illustrating the gamma voltage test unit 250 in FIG. 2 according to an exemplary embodiment of the present invention For illustrative purposes, FIG. 4 only illustrates the gamma voltage output unit 240 and the gamma voltage test unit 250 in FIG. 2.

Referring to FIG. 4, the gamma voltage test unit 250 includes a switching unit 252. The switching unit 252 selects one of the plurality of the gamma voltages V0, V1, V2, . . . , V62 and V63 outputted by the gamma voltage output unit 240 based on the gamma test signal TGM to provide the selected gamma voltage as the test gamma voltage VTG. The test gamma voltage VTG is outputted through a test terminal TG.

When the gamma voltage generating apparatus according to an exemplary embodiment of the present invention generates the gamma voltages for 64 gray levels, the gamma test signal TGM may have six bits. When the gamma voltage generating apparatus according to an exemplary embodiment of the present invention generates the gamma voltages for 32 gray levels, the gamma test signal TGM may have five bits.

When the gamma test signal TGM has a binary value of ‘000000’, a first gamma voltage V0 is selected and outputted as the test gamma voltage VTG and when the gamma test signal TGM has a binary value of ‘000010’, a third gamma voltage V2 is selected and outputted as the test gamma voltage VTG. When the gamma test signal TGM has a binary value of ‘111110’, a sixty-third gamma voltage V62 is selected and outputted as the test gamma voltage VTG, and when the gamma test signal TGM has a binary value of ‘111111’, a sixty-fourth gamma voltage V63 is selected and outputted as the test gamma voltage VTG. Thus, any one of the gamma voltages for 64 gray levels may be selected as the test gamma voltage VTG based on the gamma test signal TGM of six bits.

Although the switching unit 252 is configured to be connected to any one of the output terminals of the gamma voltage output unit 240 to select any one of the gamma voltages in FIG. 4, the switching unit 252 may be alternatively configured to be connected to at least one particular output terminal of the gamma voltage output unit 240 to select a particular gamma voltage outputted thereto.

Also, even though the gamma voltage test unit 250 is described with reference to the switching unit 252 for testing only one gamma voltage in FIG. 4, the gamma voltage test unit 250 may have two or more switching units to test two or more gamma voltages.

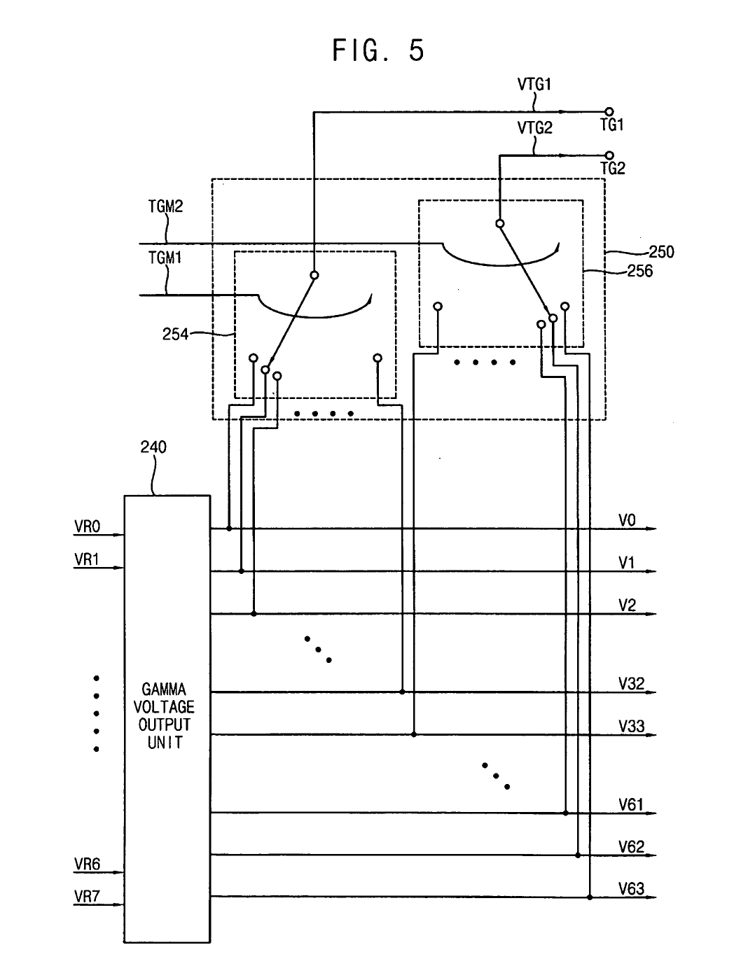

FIG. 5 is a block diagram illustrating the gamma voltage test unit 250 in FIG. 2 according to another exemplary embodiment of the present invention.

For illustrative purposes, FIG. 5 only illustrates the gamma voltage output unit 240 and the gamma voltage test unit 250 in FIG. 2.

Referring to FIG. 5, the gamma voltage test unit 250 includes first and second switching units 254 and 256. The first switching unit 254 selects one of the gamma voltages V0, V1, V2, . . . and V32 corresponding to relatively low gray levels based on a first gamma test signal TGM1 externally provided and outputs the selected gamma voltage as a first test gamma voltage VTG1 through a first test terminal TG1. The second switching unit 256 selects one of the gamma voltages V33, . . . , V62 and V63 corresponding to relatively high gray levels based on a second gamma test signal TGM2 and outputs the selected gamma voltage as a second test gamma voltage VTG2 through a second test terminal TG2.

When the gamma voltage generation apparatus according to an exemplary embodiment of the present invention generates gamma voltages for 64 gray levels, the first and second gamma test signals TGM1 and TGM2 may have five bits, respectively. In addition, when the gamma voltage generation apparatus according to an exemplary embodiment of the present invention generates gamma voltages for 32 gray levels, the first and second gamma test signals TGM1 and TGM2 may have four bits, respectively.

An operation of the gamma voltage test unit 250 in FIG. 5 is the same as already described in FIG. 4 and thus, any further descriptions are omitted.

Although the first switching unit 254 is configured to be connected to one half of output terminals of the gamma voltage output unit 240 and the second switching unit 256 is configured to be connected to the remaining one half of the output terminals to select two gamma voltages for test in FIG. 5, the first and second switching units 254 and 256 may be alternatively configured to be connected to only a predetermined output terminal of the gamma voltage output unit 240.

According to the discussion above, at least one gamma voltage to be tested is selected using a switching unit that receives the gamma test signal TGM from another unit. Alternatively, the gamma voltage to be tested may be set as a default value and outputted to a separate test terminal without using the gamma test signal.

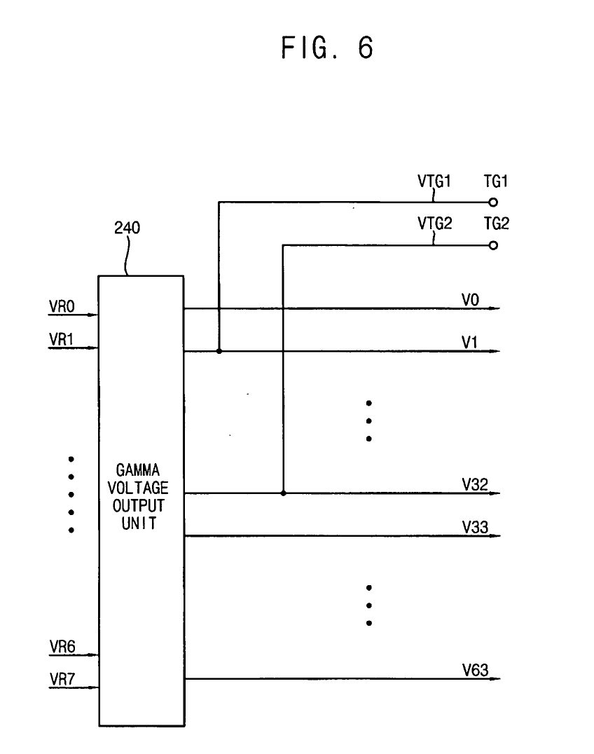

FIG. 6 is a schematic block diagram illustrating an apparatus for generating a gamma voltage according to another exemplary embodiment of the present invention. For illustrative purposes, only the gamma voltage output unit 240 is illustrated in the apparatus for generating the gamma voltage.

Referring to FIG. 6, the second gamma voltage V1 among first through sixty-fourth gamma voltages is set as a default value and provided to a first test terminal TG1. The thirty-third gamma voltage V32 is also set as a default value and provided to the second test terminal TG2. Therefore, output levels of the corresponding gamma voltages V1 and V32 are measured. Thus, at least one predetermined gamma voltage may be set as a default value to be tested.

When the gamma voltage generation apparatus according to an exemplary embodiment of the present invention is implemented in a single chip, the chip may further include first and second test terminals in addition to output terminals.

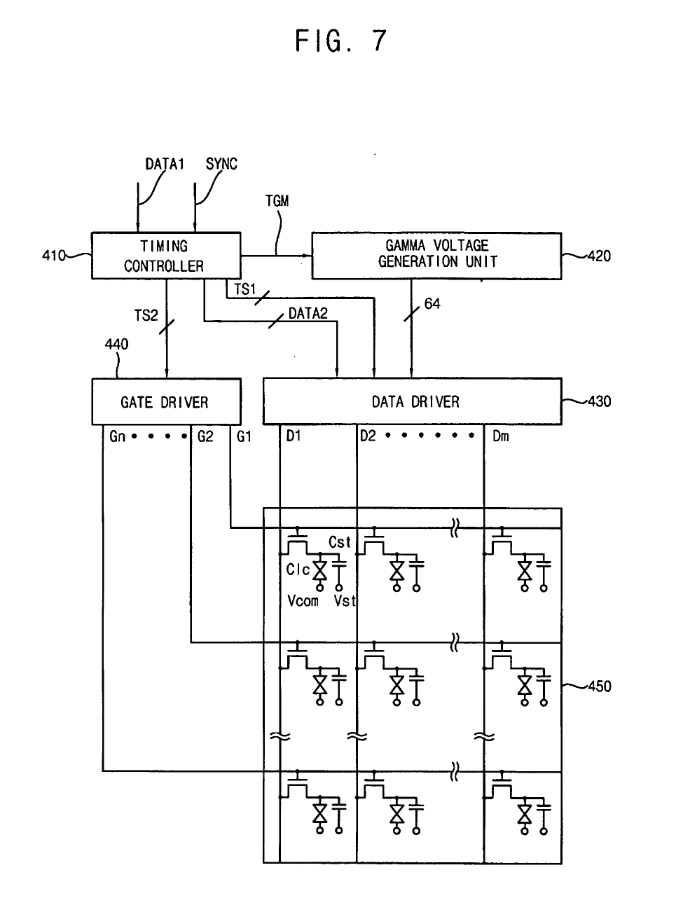

FIG. 7 is a block diagram illustrating a liquid crystal display device according to an exemplary embodiment of the present invention.

Referring to FIG. 7, the liquid crystal display device includes a timing controller 410, a gamma voltage generation unit 420, a data driver 430, a gate driver 440 and a liquid crystal display panel 450.

The timing controller 410 provides the data driver 430 with a second data signal DATA2 and a first control signal TS1, and provides the gate driver 440 with a second control signal TS2 based on a first data signal DATA1 and a synchronization signal SYNC provided from a host such as a graphic controller.

The timing controller 410 provides a gamma test signal TGM to the gamma voltage generation unit 420 in response to a gamma voltage test request from a user. For example, to test a first gamma voltage V0 among gamma voltages for 64 gray levels, the gamma test signal TGM may have a binary value of ‘000000’ and the gamma test signal TGM may have a binary value of ‘000010’ to test a third gamma voltage V2. In addition, to test a sixty-third gamma voltage V62, the gamma test signal TGM may have a binary value of ‘111110’, and the gamma test signal TGM may have a binary value of ‘111111’ to test a sixty-fourth gamma voltage V63.

The gamma voltage generation unit 420 generates a plurality of gamma voltages and provides the generated gamma voltage to the data driver 430. For example, 64 gamma voltages V0, V1, . . . , V62, V63 for 64 gray levels are generated in FIG. 7.

The data driver 430 provides a plurality of data voltages to the liquid crystal display panel 450 based on the second data signal DATA2, the first control signal TS1 and the gamma voltages. For example, the data driver 430 includes a printed circuit board (PCB), a flexible printed circuit board (FPCB) coupled to the PCB and at least one data driver chip mounted on the FPCB. Alternatively, the data driver 430 may be integrated on a peripheral area of the liquid crystal display panel 450.

The gate driver 440 provides a plurality of gate voltages in sequence to the liquid crystal display panel 450. For example, the gate driver 440 includes the printed circuit board (PCB), the flexible printed circuit board (FPCB) coupled to the PCB and at least one gate driver chip mounted on the FPCB. Alternatively, the gate driver 440 may be integrated on the peripheral area of the liquid crystal display panel 450.

The liquid crystal display panel 450 includes a plurality of gate lines, a plurality of data lines, a switching element TFT and a liquid crystal capacitor Clc and a storage capacitor Cst that are electronically coupled to the switching element TFT. The switching element TFT is formed in an area defined by two adjacent gate lines and two adjacent data lines extending substantially perpendicularly to the gate lines.

The gate line GL provides the gate voltage to the switching element TFT and the data line DL provides the data voltage to the switching element TFT. The switching element TFT is turned on or turned off based on the gate voltage to charge the liquid crystal capacitor Clc with the data voltage. The storage capacitor Cst is charged with the data voltage provided via the switching element TFT and provides the liquid crystal capacitor Clc with the charged data voltage when the switching element TFT is turned off.

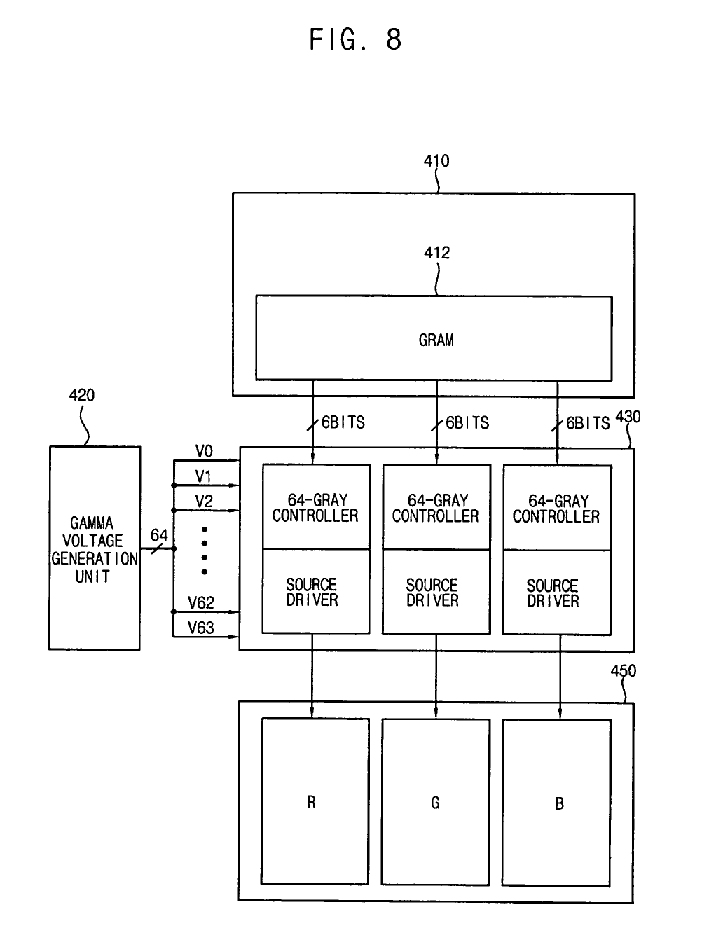

FIG. 8 is a block diagram illustrating an operation of the liquid crystal display device in FIG. 7.

Referring to FIGS. 7 and 8, a graphic RAM (GRAM) 412 included in the timing controller 410 provides the data driver 430 with 6-bit image data corresponding to a red color, 6-bit image data corresponding to a green color and 6-bit image data corresponding to a blue color.

The gamma voltage generation unit 420 provides 64 gamma voltages V0, V1, . . . , V62 and V63 to the data driver 430.

The data driver 430 includes respective 64-gray controllers and source drivers to convert RGB (red, green and blue) image data to RGB image signals. The RGB image data are converted to the RGB image signals based on the 64 gamma voltages V0, V1, . . . , V62 and V63. The RGB image signals are provided to respective pixels of the liquid crystal display panel 450 to represent the red, green and blue colors.

As shown in FIG. 8, using the RGB image data having six bits and 64 gamma voltages, a total of 64×64×64 (i.e., 262,144) colors may be represented.

As described above, according to the exemplary embodiments of the present invention, at least one test pin for testing a gray level is provided to a bump terminal of an integrated circuit (IC) for generating the gamma voltage. Therefore, an output level of the test gamma voltage may be measured using a software register.

In addition to the use of the test pin of the IC, a bit number of a register value for an IC internal command register may be adjusted according to the number of gray levels. For example, the bit number of the register value is set to five to test gamma voltages for 32 gray levels and set to six to test the gamma voltages for 64 gray levels. The register value may have a binary value varying according to the gamma voltage to be measured so that the register value is provided as the gamma test signal to output a particular gamma voltage for test through the test pin.

Alternatively, at least one test pin for a particular gray level may be provided to the IC to connect the test pin to an output terminal to which a gamma voltage corresponding to the particular gray level is outputted so that the measurement of the gamma voltage is also implemented in hardware without requiring the use of the register value.

The invention allows a precise measurement of an actual output level of the gamma voltage generated in a driver IC using an external output pin of the IC and a test instruction. The precise measurement of the gamma voltage is utilized in gamma tuning, improving the display quality, analyzing defects and generally operating the device.

Having thus described exemplary embodiments of the present invention, it is to be understood that the invention defined by the appended claims is not to be limited by particular details set forth in the above description, as many apparent variations thereof are possible without departing from the spirit or scope thereof as hereinafter claimed.

What is claimed is:

1. An apparatus for generating a gamma voltage capable of testing the gamma voltage, the apparatus comprising:
a gamma adjustment register configured to provide first and second register values for selecting the gamma voltage;
a gamma reference voltage generation unit having a first end coupled to a first supply voltage and a second end coupled to a second supply voltage to output a plurality of source gamma voltages based on the first register value;
a gamma voltage selection unit configured to select at least one of the source gamma voltages based on the second register value to output the at least one selected source gamma voltage;
a gamma voltage output unit configured to provide a plurality of gamma voltages based on the source gamma voltages received from the gamma reference voltage generation unit and the at least one selected source voltage received from the gamma voltage selection unit; and
a gamma voltage test unit configured to select at least one of the gamma voltages received from the gamma voltage output unit based on a gamma test signal externally provided.

2. The apparatus of claim 1, wherein the first supply voltage is relatively higher than the second supply voltage and the gamma voltages received from the gamma voltage output unit have output levels corresponding to respective gray levels.

3. The apparatus of claim 1, wherein the gamma test signal has a digital data varying according to a gray voltage to be tested.

4. The apparatus of claim 3, wherein the gamma test signal has a bit number adjusted according to a number of gray levels to be tested.

5. The apparatus of claim 4, wherein the gamma test signal has five bits when the gamma voltages for 32 gray levels are tested and the gamma test signal has six bits when the gamma voltages for 64 gray levels are tested.

6. The apparatus of claim 1, wherein the gamma adjustment register includes:
a gradient adjustment register configured to output the first register value for adjusting a gradient of the gray voltage relative to a gray level;
an amplitude adjustment register configured to output the first register value for adjusting an amplitude of the gray voltage relative to the gray level; and
a fine adjustment register configured to output the second register value for fine adjustment of the gray voltage relative to the gray level.

7. The apparatus of claim 1, wherein the gamma reference voltage generation unit includes a resistor string.

8. The apparatus of claim 7, wherein the resistor string includes at least one fixed resistor and at least one variable resistor.

9. The apparatus of claim 1, wherein the gamma voltage test unit includes a switching unit for selecting one of the gamma voltages received from the gamma voltage output unit based on the gamma test signal to provide the selected gamma voltage as a test gamma voltage.

10. An apparatus for generating a gamma voltage capable of testing the gamma voltage, the apparatus comprising:
a gamma voltage selection unit configured to select at least one of a plurality of source gamma voltages generated by a resistor string to output the at least one selected source gamma voltage;
a gamma voltage output unit configured to provide a plurality of gamma voltages based on the source gamma voltages received from the resistor string and the at least one selected source gamma voltage received from the gamma voltage selection unit; and
a gamma voltage test unit configured to select at least one of the gamma voltages received from the gamma voltage output unit based on a gamma test signal externally provided.

11. The apparatus of claim 10, wherein the gamma test signal has a digital data.

12. The apparatus of claim 11, wherein the gamma test signal has the digital data varying according to a gray voltage to be tested.

13. The apparatus of claim 11, wherein the gamma test signal has a bit number adjusted according to a number of gray levels to be tested.

14. An apparatus for generating a gamma voltage capable of testing the gamma voltage, the apparatus comprising:
a gamma voltage selection unit configured to select at least one of a plurality of source gamma voltages generated by a resistor string to output the at least one selected source gamma voltage;
a gamma voltage output unit configured to provide a plurality of gamma voltages based on the source gamma voltages received from the resistor string and the at least one selected source gamma voltage received from the gamma voltage selection unit; and
a gamma voltage test unit configured to output at least one gamma voltage that is set as a default value from the gamma voltages received from the gamma voltage output unit.

15. A method of testing a gamma voltage comprising:
providing first and second register values for selecting the gamma voltage;
dividing a voltage difference between a first supply voltage and a second supply voltage to output a plurality of source gamma voltages based on the first register value;
selecting at least one of the source gamma voltages based on the second register value to output the at least one selected source gamma voltage;
outputting a plurality of gamma voltages based on the source gamma voltages that are in turn outputted based on the first and second register values; and
selecting at least one of the gamma voltages based on a gamma test signal externally provided.

16. The method of claim 15, wherein the first register value includes the register value for adjusting a gradient of a gray voltage relative to a gray level.

17. The method of claim 15, wherein the first register value includes the register value for adjusting an amplitude of a gray voltage to a gray level.

18. The method of claim 15, wherein the second register value includes the register value for fine adjustment of a gray voltage relative to a gray level.
